(19) United States
(12) Patent Application Publication
(10) Pub. No.: US 2014/0222885 A1
(43) Pub. Date: Aug. 7, 2014

(54) SYSTEM FOR REAL-TIME DATA PROCESSING

(71) Applicant: UNI-B SOLUTIONS LLC, Chicago, IL (US)

(72) Inventors: Binu MOHAN, Woodridge, IL (US); Satyanarayana Reddy KAMASANI, Hyderabad (IN); Sreedhar PALEPU, Wheaton, IL (US); Sunil JOSEPH, Woodridge, IL (US)

(73) Assignee: UNI-B SOLUTIONS LLC, Chicago, IL (US)

(21) Appl. No.: 13/960,381

(22) Filed: Aug. 6, 2013

Related U.S. Application Data
(60) Provisional application No. 61/779,465, filed on Mar. 13, 2013.
(60) Provisional application No. 61/760,445, filed on Feb. 4, 2013.

(51) Int. Cl. H04L 29/08

(52) U.S. Cl. CPC H04L 67/02
USPC 709/201

(57) ABSTRACT

A real-time data processing apparatus that is connected to a user over a network, the real-time data processing apparatus comprising a data access unit that accesses user transaction data from the user, a data storage that stores orchestration process data that includes information relating to a processing of the user transaction data, a transaction processing unit that: i) accesses the user transaction data from the data access unit, ii) accesses the orchestration process data from the data storage, and iii) processes the user transaction data using the orchestration process data and a transaction data communication unit that communicates a result of the processed user transaction data in real-time to the user, wherein the real-time data processing apparatus does not store the accessed user transaction data in a non-volatile storage medium.

### CROSS-REFERENCE TO RELATED APPLICATIONS

This nonprovisional application claims the filing date benefit of U.S. Provisional Application No. 61/779,465, filed Mar. 13, 2013; and claims the filing date benefit of U.S. Provisional Application No. 61/760,445, filed Feb. 4, 2013, the disclosures of which are hereby incorporated by reference in their entireties. This application hereby further incorporates by reference U.S. patent application Ser. No. 13/827,226, filed Mar. 14, 2013, in its entirety.

### BACKGROUND

Every organization establishes operating processes to address organizational needs. To address varying operating needs, the processes differ from each other in motivation, applicability and context, specification, urgency, flexibility, impact (both desired and actual), and frequency.

Needs are often unanticipated and flexible organizations adapt quickly by establishing new processes to address new or changing needs. However, especially during periods of rapid organizational growth or in the face of abbreviated timelines, creating and managing new and established processes can be complicated due to interdependencies, conflicting or scarce resources, and other reasons that complicate process delivery, execution, and completion. Processes can involve multiple activities, actors, goals, and resources and artifacts. These complications can lead to inconsistencies and inefficiencies in the organization, which increase operational expenses and resource requirements. To adapt, organizations create methods and systems for delivering, executing, and completing the processes to ensure that the processes are aligned to organizational protocols, rules, and needs.

### SUMMARY

The organizational data to be managed is often highly sensitive. Exemplary organizational data includes information relating to payroll, employee records, and the like. Thus, in addition to efficiency issues, security becomes a concern when organizational data is transferred to an external resource management system such as a vendor specific system. Security is especially at risk when the organizational data is stored in a database outside of the full control of the organization, such as outside the organization's firewall or on the particular external resource management system's server. However, processing organizational data with the external resource management system has advantages. For example, an organization can use a variety of different solutions to address a plurality of business needs. The variety of different solutions can address needs such as finance and accounting, payroll, benefits and paid time off, surveys and assessments, company and department portals, and employee and manager self-service. The organization can use the best solution for each business need even if the solutions use different systems.

Although there are advantages to using multiple systems, it can also cause complications. Users in the organization may be directed to multiple systems having unique interfaces and different processing requirements. For example, each system can have different operating parameters, access conditions, user interfaces, login conditions, external portal compatibility issues (such as use with a mobile device, laptop, PDA, smart phone) and no user friendly design. This can cause difficulty to users in understanding how to communicate with each of the different systems. Such an effort can be time consuming and decrease the productivity and throughput of the organization. Additionally, the use of multiple systems causes organizations to integrate the multiple systems to each other so that up to date information in one system can be appropriately updated in all the other systems. Otherwise, users may be required to update the same data (for example, updating a mailing address) in a plurality of systems that require such data. Moreover, these issues are compounded when another new system to address a new business need is implemented into an organization.

In one aspect, a need for a universal data-facilitating system is provided which can be responsible for facilitating and processing data to and from a system of record (a final version of data). This universal data-facilitating system can also facilitate and process data to and from the different systems that provide solutions for the business needs of the organization so that up to date information can be stored in the proper location(s).

For example: The universal data-facilitating system can provide a universal solution to processing all data within an organization. The use of a universal data-facilitating system can streamline the processing of various data and can replace the use of multiple systems to handle various needs in an organization. As a result, users can interface one system, improving productivity and throughput of the organization. By placing the universal data-facilitating system outside of an organization's firewall, the universal data-facilitating system, for example, can be efficiently maintained and can be quickly adaptable to changing user database or software requirements by the organization or by an outside provider. Additionally, the universal data-facilitating system can allow users to enter, access and manipulate data, make a request, or initiate processing outside of the organization's firewall. This configuration provides users with increased convenience and flexibility in the submission or modification of sensitive organization data. A universal data-facilitating system can also eliminate the need for the organization to integrate the multiple systems providing solutions to the different business needs of the organization. This is because the universal data-facilitating system transfers processed data to and from the appropriate system(s) to ensure that all systems store up to date information.

Thus, in view of the above, there is a need for efficiently managing an organization's workflow processes, and specifically, processing workflow transactions, while minimizing the storage of any sensitive organizational data outside of the full control of the organization.

Embodiments of the invention provide a real-time data processing system, apparatus, method, and computer-readable medium, whereby the real-time data processing apparatus does not store user transaction data in a non-volatile storage medium.

Embodiments may include a real-time data processing apparatus that is connected to a user over a network, the real-time data processing apparatus having: a data access unit that accesses user transaction data from the user, a data storage that stores orchestration process data that includes information relating to a processing of the user transaction data, a transaction processing unit that i) accesses the user transaction data from the data access unit, ii) accesses the orchestration process data from the data storage, and iii) processes the user transaction data using the orchestration process data, and a transaction data communication unit that communicates a result of the processed user transaction data in real-time to the user, wherein the real-time data processing apparatus does not store the accessed user transaction data in a non-volatile storage medium.

The user transaction data may include a transaction request and user information relating to the transaction request. The user information may include confidential user data. The user transaction data may correspond to a workflow transaction.

Embodiments may further include a user interface that receives the transaction request and user information. The user interface may include a web-based input by which the transaction request and the user information are received.

The data storage may store orchestration process data and user authentication data to authenticate the user prior to the processing of the user transaction data.

The orchestration process data may include definitions and rules for performing workflow processes.

The data access unit may automatically access the user transaction data without a user-initiated action. Alternatively, the data access unit may access the user transaction data in response to a user-initiated action on the user interface.

The transaction processing unit may access the user transaction data and the orchestration process data using a communicator.

Prior to completion of the processing of the user transaction data, the transaction data communication unit may communicate a preliminary result of the processed user transaction data to a data layer, the preliminary result of the processed user transaction data being different than the result of the processed user transaction data.

The preliminary result of the processed user transaction data may be encrypted data, the encrypted data may be located within full control of the user. Unencrypted data including user info nation may not be located outside the full control of the user.

The data layer may be under full control of the user and accessible by the user. The real-time data processing apparatus may be located outside of a network barrier. The network barrier may be a security firewall.

The data access unit may access the preliminary result of the processed user transaction data from the data layer. The transaction processing unit may access the preliminary result of the processed user transaction data from the data access unit and may perform a final processing of the preliminary result of the processed user transaction data. The result of the processed user transaction data that is communicated to the user by the transaction data communication unit may be a result of the final processing of the preliminary result of the processed user transaction data.

The final processing of the preliminary result of the processed user transaction data may be initiated by user input that is accessed by the data access unit.

The user transaction data may be initially located inside the network barrier and may be stored under full control of the user.

The real-time data processing apparatus may be configured such that an entity authorized by the user can provide entity data to the real-time data processing apparatus and a data communication unit communicates the entity data in real-time to the user, wherein the real-time data processing apparatus does not store the entity data in a non-volatile storage medium.

Embodiments further include a method for real-time data processing by a real-time data processing apparatus that is connected to a user over a network. The method may include accessing user transaction data from the user, storing orchestration process data which includes information relating to a processing of the user transaction data, accessing the user transaction data and the orchestration process data, processing the user transaction data using the orchestration process data, and communicating a result of the processed user transaction data in real-time to the user, wherein the real-time data processing apparatus does not store the accessed user transaction data in a non-volatile storage medium.

The real-time data processing apparatus, by which the method for real-time data processing is performed, may be configured according to the variations described above.

Embodiments further include a computer-readable medium storing orchestration process data that includes information relating to a processing of user transaction data for real-time data processing, which when executed by a processor, causes a computer to function as a real-time data processing apparatus, the real-time data processing apparatus is connected to a user over a network. The computer-readable medium may include: a data access unit that accesses user transaction data from the user, a transaction processing unit that i) accesses the user transaction data from the data access unit, ii) accesses the orchestration process data from the computer-readable medium, and iii) processes the user transaction data using the orchestration process data, and a transaction data communication unit that communicates a result of the processed user transaction data in real-time to the user, wherein the computer-readable medium does not store the accessed user transaction data.

The real-time data processing apparatus, as stored on a computer-readable medium by which the computer functions, may be configured according to the variations described above.

Embodiments further include a data processing system for processing user transaction data to a user in real-time, the data processing system may include a user database that stores user transaction data, and a real-time data processing apparatus. The real-time data processing apparatus may include: a data access unit that accesses user transaction data from the user, a data storage that stores orchestration process data which includes information relating to a processing of the user transaction data, a transaction processing unit that i) accesses the user transaction data from the data access unit, ii) accesses the orchestration process data from the data storage, and iii) processes the user transaction data using the orchestration process data, and a transaction data communication unit that communicates a result of the processed user transaction data in real-time to the user, wherein the real-time data processing apparatus does not store the accessed user transaction data in a non-volatile storage medium.

The real-time data processing apparatus, as included in the real-time data processing system, may be configured according to the variations described above.

### BRIEF DESCRIPTION OF THE DRAWINGS

The foregoing and other objects, features, aspects and advantages of the invention will become more apparent from the following detailed description when taken in conjunction with the following accompanying drawings.

FIG. 1 is a schematic diagram showing an exemplary logical architecture of the real-time data processing apparatus according to embodiments of the invention.

FIG. 2 is a schematic diagram showing an exemplary embodiment of a real-time data processing system in which user transaction data is processed in real-time.

FIG. 3 is a schematic diagram showing an exemplary embodiment of a real-time data processing system in which user transaction data can be accessed via a user interface.

FIG. 4 is a schematic diagram showing an exemplary embodiment of a real-time data processing system in which the real-time data processing apparatus interacts with a user and a customer.

FIG. 5 is a flow diagram illustrating an exemplary method for real-time data processing.

### DETAILED DESCRIPTION OF THE EMBODIMENTS

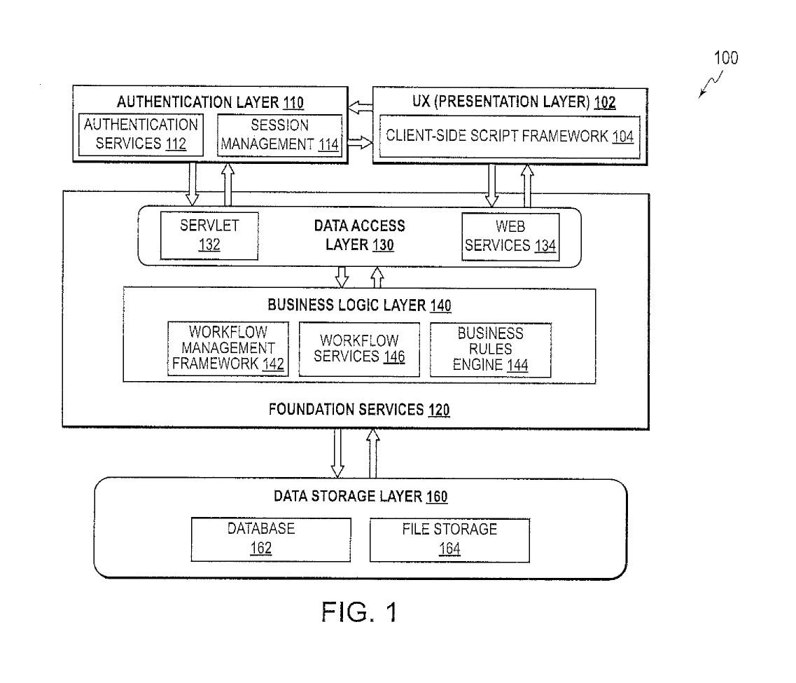

Embodiments of the invention are described below with reference to FIGS. 1-5.

Embodiments of the invention provide a real-time data processing device for processing user data, whereby the real-time data processing apparatus does not store user transaction data.

As used herein, an apparatus that processes data according to the term “real-time” can be an apparatus that does not store data in a non-volatile storage medium. Rather, the apparatus can act as a pass through data facilitation layer. Data can be stored within the apparatus in a volatile storage medium such as a random-access memory (RAM). The volatile storage of data can allow for dynamic use of the data and the immediate destruction of the data after the data is processed, transferred or once the session is terminated.

As used herein, the term “user” means any user of the real-time data processing apparatus, which may include, for example, a customer, client, employee, administrator, organizational entity, and the like. The user may have security requirements that certain sensitive data, especially which relate to their workflows, cannot be stored in an unencrypted form anywhere outside of the user's firewall(s) (i.e., real-time data processing-side) or outside the full control of the user.

The real-time data processing apparatus can act as a data interface layer to integrate with any existing technology, database, client device or back end system. For example, the real-time data processing apparatus can interface with a user system that is not integrated and includes multiple databases. Alternatively, the real-time data processing apparatus can interface with an integrated user system and return processed data to any location desired by the user. The real-time data processing apparatus can function as a data facilitator layer for any existing system to receive data, process the data and return the processed/manipulated data back to the system without database storage of the received data outside of the system. The data can be frequently changing. Thus, an adaptable and flexible real-time data processing apparatus is desired to accommodate and process the dynamically changing data. Embodiments provide for a real-time data processing apparatus with increased efficiency, security, and flexibility, as described further below.

FIG. 1 is a schematic diagram showing an exemplary logical architecture of the real-time data processing apparatus 100 according to embodiments of the invention.

The apparatus 100 can include logically distinct layers and components of features of embodiments, for example, the software components of a multi-tier web-based application. The apparatus 100 may include: a UX or presentation layer 102 that includes a client-side script framework 104; an authentication layer 110 that includes authentication services 112 and session management 114; foundation services 120, including a data access layer 130 with servlet 132 and web services 134, and a business logic layer 140 with workflow management framework 142, business rules engine 144, and workflow services 146; and a data storage layer 160 that includes database 162 and file storage 164.

Each layer and component within the apparatus 100 can represent a set of instructions stored on a computer-readable medium. The computer-readable medium is preferably tangible and non-transitory. The computer-readable medium can be any volatile or non-volatile storage medium such as a RAM, a hard disk drive, removable media, EEPROM, flash memory, holographic memory, or any combination thereof. The instructions can be stored in any computer-readable format, whether as object code or source code, and execution of the instructions can include compilation, interpretation, or anything else that prepares code for execution by a processor. The processor can be any hardware processor that can execute computer code including a CPU, an MPU, an ASIC, a (GP) GPU or VPU, a PPU, a DSP, an FPGA, or any combination thereof.

The inter-layer and inter-component communication of the apparatus 100 can use any application level messaging protocol or specification, whether synchronous or asynchronous, that provides for data exchange to produce a format understood by the receiver of the message. For example, the layers and components can communicate with one another directly using JSON messages or indirectly using message queues (e.g., SonicMQ) or a bus. Further, a variety of communications can be used between the layers and components and even between the same two layers and/or components. The communication can be encrypted or otherwise secured, for example, using SSL or TLS.

The presentation layer 102 can allow a user to provide input to and receive output from the real-time data processing apparatus 100. On the front end, the presentation layer 102 may receive input from and return output to a user through a web-based interface or any other network interface that facilitates communication over a network such as the Internet. The web-based interface can be a webpage that is formatted for a specific platform, such as a class of devices and/or web browsers. The web-based interface can communicate over HTTP/S. Alternatively, a single request or response may have both HTTP and HTTPS elements. The communication can use any transport layer protocol such as TCP, UDP, DCCP, SCTP, RSVP, or combination thereof.

The web-based interface preferably employs a lightweight and fast client-side script framework 104, such as JavaScript, that allows the user to execute client-side scripts to manipulate data and the presentation of data on the client-side machine. This reduces the amount of processing and network traffic handled by the real-time data processing apparatus 100 and also allows each user to download and execute client-side scripts that can be customized to the user's particular environment. The presentation layer 102 may employ any method for detecting the browser and/or platform type in order to ensure that the response data is properly formatted for presentation, including the JavaScript BrowserDetect, Browser, and navigator objects; HTTP GET/POST methods; or jQuery browser object.

On the back end, the presentation layer 102 may communicate with the data access layer 130 indirectly through the authentication layer 110 or directly with the data access layer 130 if no authentication and authorization is required.

The authentication layer 110 can authenticate and/or authorize users of the real-time data processing apparatus 100. The authentication layer 110 can either communicate with users through the presentation layer 102 or communicate directly with users through an Application Programming Interface API (not shown) or a Representational State Transfer—REST API. An API is a set of routines, protocols and tools for building software applications. A REST API is a specific type of API that can offer a more controlled experience because mapping of the REST API is predetermined prior to execution. This mapping is agreed upon between the user and the real-time data processing apparatus 100 and provides for a concise search during operation. As a result, operational efficiency is improved and problems arising during operation are minimized. Operation of the REST API will be discussed in further detail below.

The authentication services 112 can include authorization services provided by an authority server. The authority server can exchange authentication and/or authorization information with the presentation layer 102 and/or the data access layer 130 using any specification that allows the authentication layer 110 to appropriately authenticate the user and authorize the user to read, modify, and/or create resources. For example, the authority server can employ the SAML or OpenID specifications for authentication data exchange.

Once the user is authenticated and authorized to use the real-time data processing apparatus 100 (through the data access layer 130), the session management 114 can manage session initiation and termination. For example, the session management 114 may create a validation token that is associated with the user's session. The validation token allows the user to continue to communicate with the real-time data processing apparatus 100 without having to re-authenticate or re-authorize every new request within the session. The session management 114 can revoke or destroy the validation token to terminate the session.

The authentication layer 110 can communicate directly with users through a variety of known methods without invoking the functions of the presentation layer 102. For example, external systems can batch datasets to the data access layer 130 through the authentication layer using HTTP/S GET/POST requests.

The data access layer 130 can be considered part of the foundation services 120 and can provide a channel for users to receive data. The servlet 132 can include a web container such as Apache Tomcat, Jetty, Moss, WebLogic, WebSphere or any other web container that manages servlet instances. The data access layer 130 can also include web services 134 that allow bi-directional web-based communications, for example, using SOAP, WSDL, or any other specification that allows for the exchange of structured information over the web. The servlet 132 can alternatively be a REST API or a JSON, for example.

On the front end, the data access layer 130 can receive requests and sends responses through the authentication layer 110 and/or the presentation layer 102. Alternatively, the data access layer 130 can receive requests and/or send responses that bypass the authentication layer 110 and the presentation layer 102 if authentication, authorization, and presentation are not needed. For example, the data access layer 130 can use a web services REST API for data import and/or export. On the back end, the data access layer 130 can communicate with the business logic layer 140 or with the data storage layer 160.

On the front end, the business logic layer 140 can receive data from and/or returns data to the data access layer 130. The business logic layer 140 can process business logic that drives business workflows. For example, requests from the data access layer 130 can invoke the functions of the workflow management framework 142, the business rules engine 144, and/or the workflow services 146.

The workflow management framework 142 can manage the workflow framework by, for example, processing requests for creating, modifying, and deleting workflows. The workflow management framework 142 can use a known flow framework platform such as Amazon's AWS Flow Framework.

The business rules engine 144 can manage the business rules by, for example, evaluating a workflow status and determining which rule(s) to apply. The business rules engine 144 can also process requests for creating, modifying, or deleting rules via a user request or preprogrammed intelligence. The business rules engine 144 can use a known business rules management system such as OpenRules's Business Rules Engine. For example, a building construction job that requires a specific set of subcontractors who have guaranteed their availability can include a multiplicity of workflows. The client might have specific needs, for example, that the subcontractor that installs the plumbing be able to supply and install PEX piping. The apparatus 100 can search a database of known subcontractors with experience in PEX piping who have made bids on the job and present a list of known subcontractors who fit the criteria for user selection, tentatively assign the plumbing track to the most preferred subcontractor (ranked in any manner selected by the client, for example, by price or by work history or any combination of those or similar factors) subject to user approval, or assign the plumbing track to the most preferred subcontractor automatically. The factors identified by the client that are used to determine the ranking of the subcontractors correspond to a predefined criteria and selection algorithm(s). The predefined criteria and selection algorithm(s) are stored as business rules, which are managed by the business rules engine 144.

The workflow services 146 can manage the workflows by, for example, managing communications between workflows and manipulating workflow data upon various triggers based on the business rules.

On the back end, the business logic layer 140 can communicate with the data storage layer 160.

On the front end, the data storage layer 160 can communicate with the foundation services 120. The data storage layer 160 can process data storage, modification, and retrieval requests for data stored in the database 162 and/or for files stored in the file storage 164. The database 162 can be any type of database such as a relational database management system (RDBMS) or a non-sequel database (NoSQL). NoSQL databases provide the benefit of minimal database structure so that multiple entries can be created instantaneously. This can result in a data storage layer 160 that is adaptable and flexible to user requirements. Exemplary NoSQL databases include Mongo and Couch databases.

Any of the foregoing layers or components therein can be provided on one or more physical computing machines and can be spread through a variety of locations. For example, an administrator's security requirements may mandate that authentication and authorization services be provided in a site subject to full control by the administrator. In this situation, the authentication layer 110 can be provided as a separate computing unit within the administrator's protected network, while the remainder of the real-time data processing apparatus 100 is provided on computing units in a remote location or multiple remote locations.

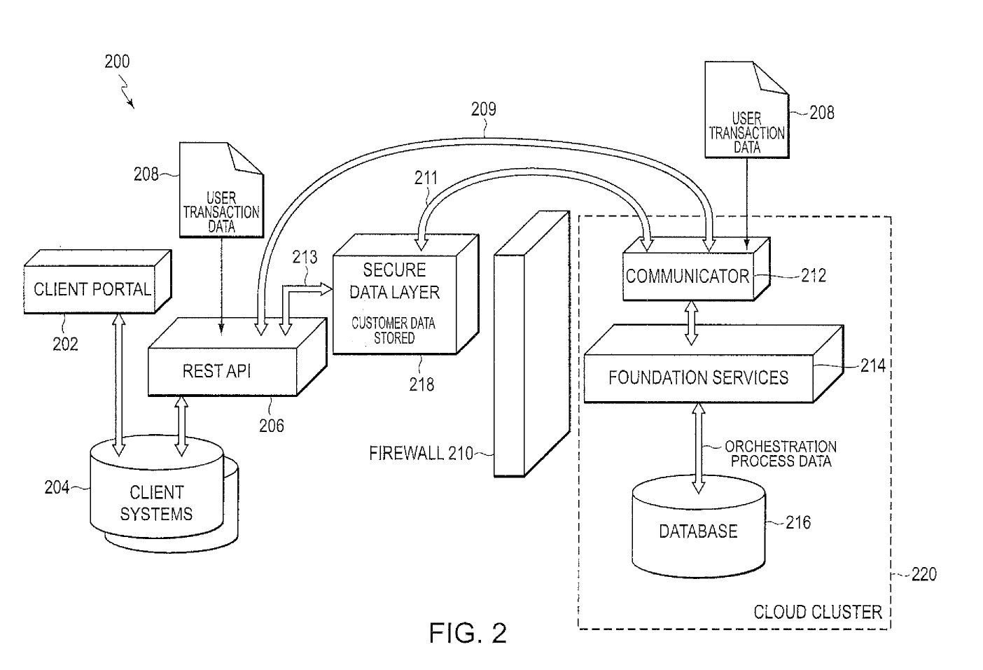

FIG. 2 is a schematic diagram showing an exemplary embodiment of a real-time data processing system 200 in which user transaction data 208 is processed in real-time.

In the real-time data processing system 200, the user can create a request to access the real-time data processing apparatus, for example, to execute a step in a workflow, through a client portal 202 on the front end. The client portal 202 can forward the request to backend client systems 204. The client systems 204 can be referred to as a system of record that stores a final version of data (user information). The client systems 204 can translate the request through a provided REST API 206 into the relevant user transaction data 208. The user transaction data 208 can be encrypted before the REST API call is invoked or the REST API 206 can encrypt the user transaction data 208.

The REST API 206 can act as a messaging post that can receive and send data and communicate between two application servers. A url in the REST API 206 can dictate what information is to be exchanged. The url link in the REST API 206 can be configured not to hold a current state of data. Accordingly, the REST API 206 can capture the current or intended state of the data and present the data on a browser while not storing the data in a database. In other words, the interaction of the REST API 206 is stateless between requests.

Mapping of the REST API 206 and creating the url link identifying the data to be communicated can be predetermined by the user and the real-time data processing apparatus prior to execution. This predetermined arrangement can improve security and efficiency as the user can define the operational commands and identify the specific type of data to be communicated.

For example, the real-time data processing apparatus can provide to a user a system to manage a group of computers. The real-time data processing apparatus can oversee a group of computers and specification data related to each of the computers. The real-time data processing apparatus can communicate, using JSON messages, computer specification data to and from the user to add, modify or delete data. Some exemplary commands that can be used through JSON messaging between the real-time data processing apparatus and the user include the following: (1) a “get” command that allows the real-time data processing apparatus to receive a list of computers from the user; (2) a “post” command that allows the real-time data processing apparatus to add a new computer to the list of computers and return an updated list of computers to the user; (3) a “put” command that allows the real-time data processing apparatus to identify one computer in the list of computers, update specification data related to the identified computer and return the updated specification data of the identified computer to the user; and (4) a “delete” command that allows the real-time data processing apparatus to delete a computer from the list of computers and return an updated list of computers to the user.

The REST API 206 can be located inside of a firewall 210. Alternatively, the REST API 206 can be located outside of the firewall 210 but under the full control of the user. The position of the REST API 206 can be determined by the client based on various system requirements such as security and accessibility.

The user transaction data 208 can include any data that is related to a transaction to be processed as initiated by the user. The user transaction data 208 may include a transaction request and/or user information relating to the transaction request. The transaction request may include the action that the user wishes to perform, while the user information relating to the transaction request may include the user information to be processed in accordance with the transaction request.

The user transaction data 208 may include a plurality of actions to be performed, i.e. a workflow transaction, involving a series of steps (or tasks), tracks and business rules (see U.S. patent application Ser. No. 13/827,226 for further information regarding a workflow transaction).

For example, a user may wish to update a mailing address. In such case, the user transaction data 208 includes a transaction request (i.e., update mailing address), and user information relating to the transaction request (i.e., the updated mailing address). Frequently, the user information includes confidential user data. Thus, the user may desire heightened security, minimize storage of the user information outside of a network barrier or minimize storage of the user information outside the full control of the user. These precautions may help prevent the user information from being accessed by unauthorized users. The network barrier is a medium through which data is communicated. The network barrier can preferably be a security firewall 210.

A secure connection 209 can be established between the communicator 212 and the REST API 206 prior to authentication and regardless of the result of authentication. This connection can take place within a network. The REST API 206 can then invoke a secure HTTPS POST method containing the encrypted user transaction data 208 to the communicator 212 located outside of the firewall 210 (i.e., real-time data processing-side). The communicator 212 can be, for example, a REST API, a Java servlet or a JSON. The communicator 212 can then decrypt the encrypted user transaction data 208 or the communicator 212 can forward the encrypted user transaction data 208 to the foundation services 214 for decryption and processing. The foundation services 214 can decrypt the encrypted user transaction data 208 and/or process the decrypted user transaction data 208 further by applying internal system process data through queries to the database 216. The processing can occur in real-time without ever storing the user transaction data 208 on a non-volatile medium. Thus, even running in a Software-As-A-Service (SaaS) configuration, the system 200 can meet an organization's security requirements that certain sensitive data cannot be stored in an unencrypted form outside of the organization's firewall or outside the full control of the user.

To complete the processing, the foundation services 214 can create an encrypted response that is then returned to REST API 206 through the communicator 212. The encrypted response is a result of the processed user transaction data 208. In the example referenced above, a user may wish to update a mailing address. In such case, the foundation services 214 receives the user transaction data 208 through the communicator 212, and initiates processing of the user transaction data 208 using orchestration process data (described below). After processing of the user transaction data 208 is complete, a result of the processed user transaction data 208 (i.e., confirmation that the mailing address is properly updated) can be communicated to the user on the inside (i.e., user-side) of the firewall 210.

The real-time data processing system 200 can use internal messaging, for example, web services calls and JSON native communication, on demand for inbound and outbound system and sensitive user transaction data 208 so as to communicate the sensitive user transaction data 208 between physical or virtual machines in encrypted form only. The sensitive user transaction data 208 can be decrypted and manipulated at a single logical component (e.g., foundation services 214 can run on a single machine) in memory before being re-encrypted. Thus, the sensitive user transaction data 208 is never stored on a non-volatile medium of the real-time data processing system 200, thereby helping to ensure that sensitive user transaction data 208 is not stored outside the full control of the user in an unencrypted form.

Preferably, the database 216 can reside outside of the firewall 210. Alternatively, the real-time data processing apparatus including the database 216 can be located within the firewall 210 if desired by the client. However, such a configuration may not be necessary for the reasons discussed below. The database 216 may be of any suitable type, including, for example, a relational database such as MySQL. The database 216 may store orchestration process data and/or authentication data. The orchestration process data can include data used by the foundation services 214 to process the user transaction data 208. The orchestration process data may include, for example, authentication steps, process names, process types, process steps, definitions, workflow rules (e.g. due dates, conditions), and the like. The authentication data can include data used by the authentication layer 110 to authenticate a user prior to the processing of the user transaction data 208. The authentication data may include, for example, a login ID, password, session information, minimal contact information (i.e., email address), and the like. Authentication data may not be considered as client sensitive data within the context of this invention.

Because the database 216 can reside outside of the firewall 210 and outside the full control of the user, user transaction data 208 is not stored thereon or on any other non-volatile storage medium. Rather, user transaction data 208 can be stored within the random-access memory (RAM) of the database 216 for dynamic use and destroyed after the user transaction data 208 is processed e.g., once the session is terminated.

This configuration provides a plurality of advantages as described herein. The user transaction data 208 remains stored only on the user's database, preferably on the inside (i.e., user-side) of the firewall 210, thereby securely preserving potentially sensitive user data. Storage of the user transaction data 208 in one location improves efficiency, reduces redundant storage of data and reduces multiple database storage costs. Additionally, because the user transaction data 208 is not stored in the database 216, efficiency of transaction processing increases, and allows for processing to occur in real-time. Further, real-time processing of user transaction data 208 ensures that the latest data is processed. There is a danger of processing old user transaction data 208 if the user transaction data 208 is stored on database 216. Any dynamic changes to the user transaction data 208 may not be identified prior to processing if the user transaction data 208 is stored on database 216. Since the user transaction data 208 is not stored in the database 216, up to date user transaction data 208 will always be received prior to processing. Furthermore, this configuration allows for a short implementation time or a short time for the system 200 to go live. This configuration focuses on what data is to be processed, which can take place rather quickly.

Generally, third party systems known in the art prefer to store user data in a non-volatile storage medium for processing outside of the full control of the user because it is easier to manipulate data that the third party has control over. However, as discussed above, the real-time data processing apparatus does not store user data in a non-volatile storage medium and is not even concerned with the actual content of the specific user data to be processed. Rather, the real-time data processing apparatus can identify the type of specific user data, manipulates the user data based on the orchestration process data and returns the processed data in real-time to the user.

The real-time data processing apparatus may reside within cloud cluster 220. More specifically, the communicator 212, the foundation services 214, and the database 216 may reside within the cloud cluster 220. The cloud cluster 220 can use a known framework, such as Amazon's AWS Flow Framework. The cloud cluster 220 can be located on the outside of the firewall 210 (i.e., the processing-side). The communicator 212 can transfer orchestration process data within the cloud cluster 220. The communicator 212 can also receive and/or communicate user transaction data 208. The user transaction data 208 being received and/or communicated by the communicator 212 may be fully processed, partially processed (as described below), or yet-to-be processed using the orchestration process data, by the foundation services 214.

A secure connection 211 can be established between the communicator 212 and a secure data layer 218 prior to authentication and regardless of the result of authentication. This connection can take place within a network. Such a connection can enhance the security of the confidential data exchanged.

A secure connection 213 can also be established between the REST API 206 and the secure data layer 218 prior to authentication and regardless of the result of authentication. This connection can take place within a network and inside or outside of the firewall 210. Such a connection can enhance the secure of confidential data exchanged in various ways. For example, the secure connection 213 may remove the need for the secure connection 211. In this manner, the communicator 212 can only communicate to the client via a single secure connection 209 to the REST API 206. Additionally, the REST API 206 and the secure data layer 218 can be inside the firewall 210 and under full control of the user.

The secure data layer 218 can permanently store data under the full authority and control of the client. Alternatively, the secure data layer 218 can temporarily store data. The following embodiment describes the temporary storage of data by the secure data layer 218. However, the permanent or temporary storage of data by the secure data layer 218 can be interchangeable in the following embodiment unless otherwise stated.

An encrypted result of the processed user transaction data 208 may be temporarily or permanently stored in secure data layer 218 that can be accessible by the user and within the full control of the user. In such case, the encrypted result that is temporarily or permanently stored is a preliminary result of the processed user transaction data 208. In other words, the processing of the user transaction data 208 is not fully complete, and additional processing of the data is required in order to complete the transaction. The transaction process may be considered to be in a “bookmarked state.” When the processing resumes, the semi-processed user transaction data 208 can be accessed from the secure data layer 218 by the communicator 212, and passed to foundation services 214 to complete the processing.

When the preliminary result of the processed user transaction data 208 is communicated to the secure data layer 218, the real-time data processing apparatus may be configured such that resuming the processing is initiated only upon receipt of user input. The user input may include, for example, confirmation of the transaction. The user input may be received via the presentation layer 102, authentication layer 110, or data access layer 130, as described above or the client systems 204. If user input is not received within a predetermined amount of time, the transaction may have a time out, and the preliminary result of the processed user transaction data 208 may be erased from the secure data layer 218.

Preferably, the entity providing the user input (i.e., confirming the transaction) will be different than the original user. Requiring transaction confirmation from an entity other than the original user allows for increased security and prevents transactions that may be erroneous, or even dangerous. For example, if an employee wishes to update payment preferences, a preliminary result of the processed user transaction data 208 (i.e., notification of the desired change) may be reviewed by a member of a Human Resources (FIR) department. If the HR member confirms the transaction, the final processing of the user transaction data 208 is initiated. Accordingly, the appropriate information of the final processing is stored in the client systems 204. On the other hand, if the HR member disapproves of the transaction, the transaction is canceled. In this manner, employees are prevented from making unauthorized changes to potentially sensitive records.

The secure data layer 218 can be located inside of the firewall 210 (i.e., user-side), and thus is accessible to the user. The secure data layer 218 can be positioned at any desired location inside of the firewall 210 as requested by the user. Alternatively, the secure data layer 218 can be located outside the firewall 210 but under the full control of the original user or to whom the user grants control to. For example, the secure data layer 218 can be located within a cloud cluster where the user has full control over. The secure data layer 218 may be any suitable database, including, for example, a server device, a cloud-based database, a web server written in JavaScript and the like. The secure data layer 218 can store user transaction data 208 in cache memory. In another alternate configuration, the secure data layer 218 can communicate with client systems inside and outside the firewall 210. The secure data layer 218 can be located inside or outside the firewall 210 and can act as a communication bridge between all of the client systems and the real-time data processing apparatus.

The secure data layer 218 may be controlled and/or accessible by a user such as an employee. More preferably however, the secure data layer 218 is not controlled by the user (employee). In such case, the preliminary result of the processed user transaction data 208 may only be accessed by an entity authorized by the client. This arrangement is advantageous, for example, within an organization (client), where employee (user) transactions require approval from a member of the HR department (entity authorized by the client).

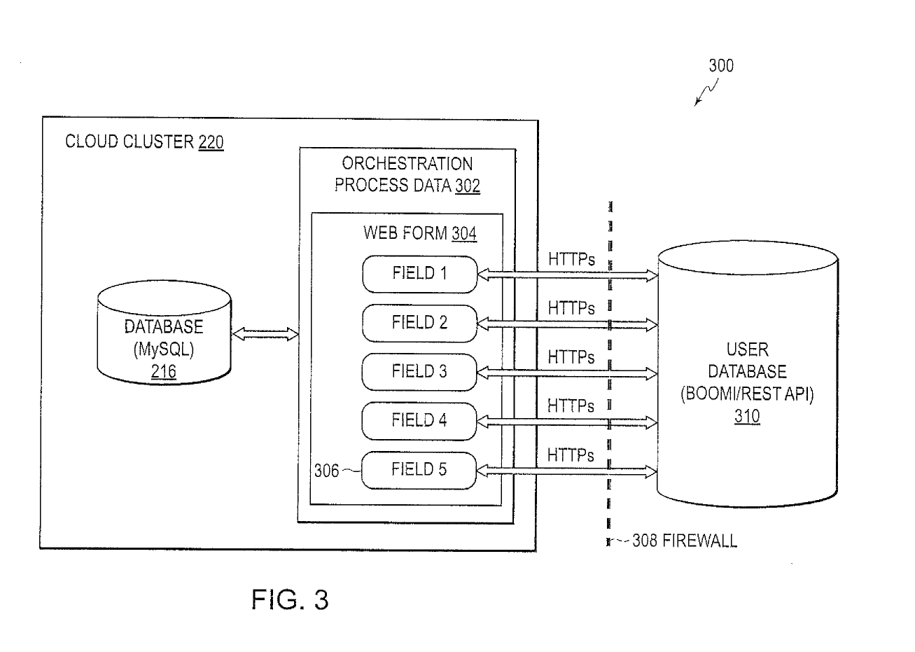

FIG. 3 is a schematic diagram showing an exemplary embodiment of a real-time data processing system 300 in which user transaction data can be uploaded from a user interface 310 via a user interface.

As explained above, the real-time data processing apparatus may reside within the cloud cluster 220. More specifically, the database 216 may reside within the cloud cluster 220. The database 216 may store orchestration process data 302, which includes, for example, a web-based form 304 which may be accessed by the user. The web-based form 304 may receive input from the user, such as user transaction data 208. The web-based form. 304 may receive and communicate user transaction data 208 via any suitable web-based communication means, including, for example, HTTP/S, SSL, the REST API, and the like.

The web-based form 304 is an example of a “user interface” and can facilitate the real-time transfer of user transaction data 208 between database 216 and user database 310 via the communicator 212 illustrated in FIG. 2. It should be noted that the real-time transfer of user transaction data 208 between user database 310 and database 216 may require that the user transaction data 208 cross the firewall 308, since the user database 310 may reside inside of the firewall 308, while the database 216 resides outside of the firewall 308. The firewall 308 ensures that a secure real-time transfer of user transaction data 208 takes place.

The web-based form 304 may include a plurality of fields 306. The fields 306 are configured to receive user transaction data from the user. The user may input information into the fields 306 via any suitable web-enabled terminal, including, for example, a mobile device, desktop PC, laptop, PDA, tablet, and the like. The fields 306 do not necessarily have to be textual input fields, but may be of any suitable input form, including, for example, drop-down menus, radio buttons, and the like. Further, information in the fields 306 may be pre-entered by the real-time data processing apparatus, so as to allow a user to merely select options corresponding to the desired data, rather than having to manually input the desired data.

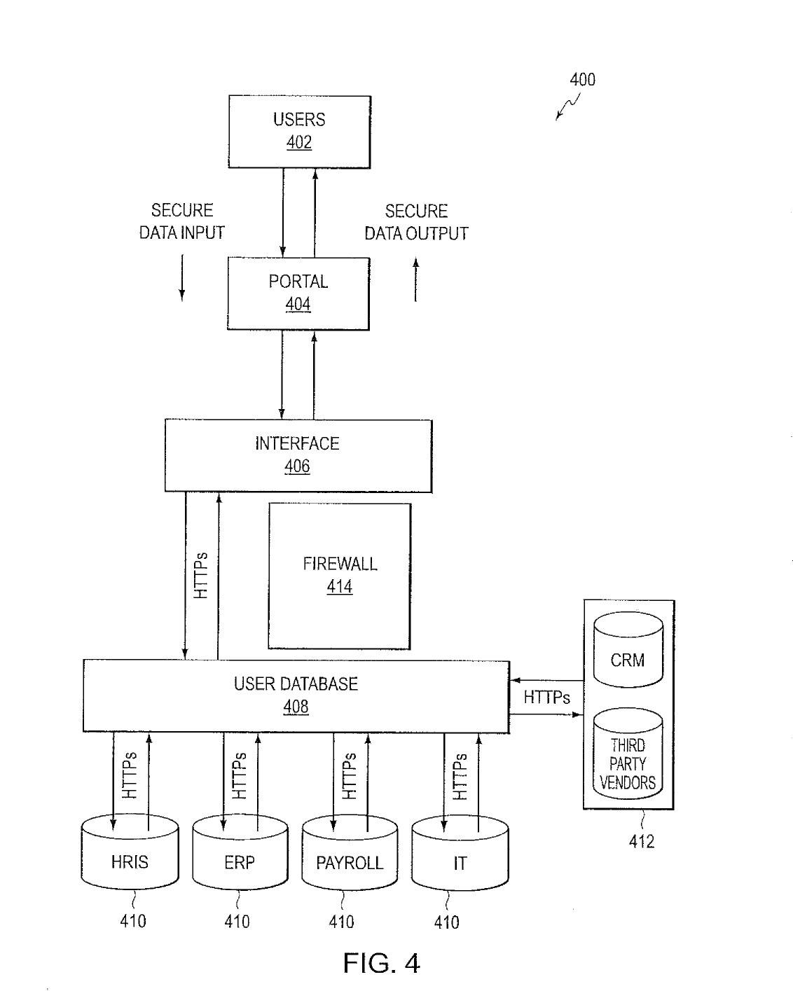

In an exemplary embodiment, the user may first login to the real-time data processing system via the presentation layer 102 illustrated in FIG. 1. Then, the user creates a transaction request. For example, the transaction request may include updating an employee's address. The user of the system may be the employee. Next, the user may be authenticated via the authentication layer 110. However, the real-time data processing system 300 may be configured such that the user may proceed without prior authentication. Subsequently, the user enters information into at least one of the fields 306. In the case that the transaction request involves updating an employee's address, the information entered into the fields 306 may include the updated address. Then, the user would execute the transaction by any suitable means, including, for example, a “submit” button (not shown). Preferably, when all the fields 306 are filled, a single call is made upon activation of the “submit” button to transmit all the entered data in each of the fields 306. The entered data can now become the user transaction data 208 and can be subsequently encrypted. The encrypted user transaction data 208 can then be communicated in real-time across the firewall 308 to the user database 310 for database storage. This configuration can allow for an employee to update or provide user transaction data 208 outside of the firewall 308. This feature provides advantages of flexibility and convenience by allowing an employee to use a variety of portals (as discussed in further detail with respect to FIG. 4) to access or modify transaction requests or to initiate transaction requests outside of the firewall 308 (i.e., outside of the workplace).

To initiate processing of the user initiated transaction request, the encrypted user transaction data 208 can be retrieved from the user database 310. The encrypted user transaction data 208 can be subsequently decrypted and the decrypted user transaction data 208 can be processed by the real-time data apparatus outside of the firewall 308, as described above. Finally, the result of the processed user transaction data, which may include confirmation of the transaction and/or the updated address, can be encrypted and communicated by the real-time data processing apparatus back to the inside of the firewall 308. Thus, the user transaction data 208 is never stored in the database 216.

The user database 310 may be of any suitable storage type, including, for example, a server device, a cloud-based database, and the like. Alternatively, the user database 310 may be substituted for the REST API 206 or the client systems 204 as illustrated in FIG. 2. The user database 310 stores information relating to the user, including, for example, employee records, company job codes, location information, and the like. Because the information stored on the user database 310 is often sensitive, the real-time data processing apparatus does not store any of this information outside the full control of the user. Instead, this information remains only on the user database 310, which can be inside of the firewall (i.e., user-side) and under the full control of the user, so as to securely preserve user information on the user's own storage device. Moreover, preventing the user's information, i.e., user transaction data, from being stored in the real-time data processing apparatus increases efficiency by decreasing overall processing time.

FIG. 4 is a schematic diagram showing an exemplary embodiment of a real-time data processing system 400 in which the real-time data processing apparatus interacts with a user and a customer.

According to embodiments, a user and a customer may interact with the real-time data processing apparatus conjunctively. A customer may be any entity which subscribes, for example, to use services provided by the real-time data processing apparatus. A subscription-based relationship is an exemplary mariner in which the customer may enter into an agreement to utilize the real-time data processing apparatus. The customer may include, for example, an employer, a Human Resources department, a governmental entity, or any other organizational entity. On the other hand, a user may be any entity which actually initiates a transaction with the real-time data processing apparatus. The user may include, for example, employees, contractors, external customers, job candidates, alumni, retirees, and the like. Thus, in some embodiments, the user and the customer differ in that the user can be an individual within an organization, while the customer can be the organization that subscribes to the real-time data processing apparatus.

The real-time data processing system 400 may include users 402 that interact with interface 406 via a portal 404. A transaction request can be produced at interface 406 and communicated to user database 408. The user database 408 may access the customer databases 410. The user database 408 may be compatible with ancillary storage units 412. The firewall 414 provides a security barrier between the data stored on the user database 408 and customer databases 410, and the real-time data processing apparatus via interface 406.

The users 402 may interact, i.e., initiate transactions, with the interface 406 of the real-time data processing apparatus via a web-enabled portal 404. The portal 404 may be any suitable web-enabled device, including, for example, a mobile device, laptop, PDA, smart phone, and the like. The portal 404 can access the interface 406. The interface 406 may be a web-based form, as in the web-based form 304 illustrated in FIG. 3, or any other similar web interface.

The interface 406 can communicate the transaction request initiated by the user 402 through the firewall 414 and to the user database 408. The interface 406 can communicate with the user database 408 via any suitable web-based communication means, including, for example, HTTP/S, SSL, the REST API, and the like. The interface 406 may include, for example, the presentation layer 102. The interface may further include the foundation services 120. As such, the interface 406 may be capable of processing the transaction request initiated by the user 402.

The user database 408 can be coupled to at least one customer database 410. The customer databases 410 may include any suitable storage means for storing customer data. The user transaction data may include data relating to the customer, i.e., the corresponding organizational entity. The customer databases 410 may store data relating to, for example, Human Resources Information Systems (HRIS), Enterprise Resource Planning (ERP), payroll records, Information Technology (IT), and the like. Such user transaction data may be communicated to the user database 408 from the respective customer databases 410, or vice versa. The communication of user transaction data is based on the transaction request that can be initiated by the user 402 via portal 404, processed by the interface 406, and communicated by the interface 406 to the user database 408.

The user database 408 can be compatible with ancillary storage units 412. The ancillary storage units 412 may be of any suitable storage type, including, for example, a customer relationship management storage unit, and storage hosted by a 3^{rd} party. The ancillary storage units 412 preferably employ a cloud-based storage architecture. Such cloud-based storage architecture may include, for example, a storage service such as Dell's Boomi® or Fusion, which allows for integration of cloud, Software as a Service (SaaS), or other on-premise applications without additional appliances, software, or coding. Placing the user database 408 on a web server in a cloud can allow the user to store and update database data outside of the firewall 414 but under full control of the user. Security is maintained in such a configuration because a third party has no access to code on the web server in the cloud. As a result, the user can maintain sole control and access to the database data.

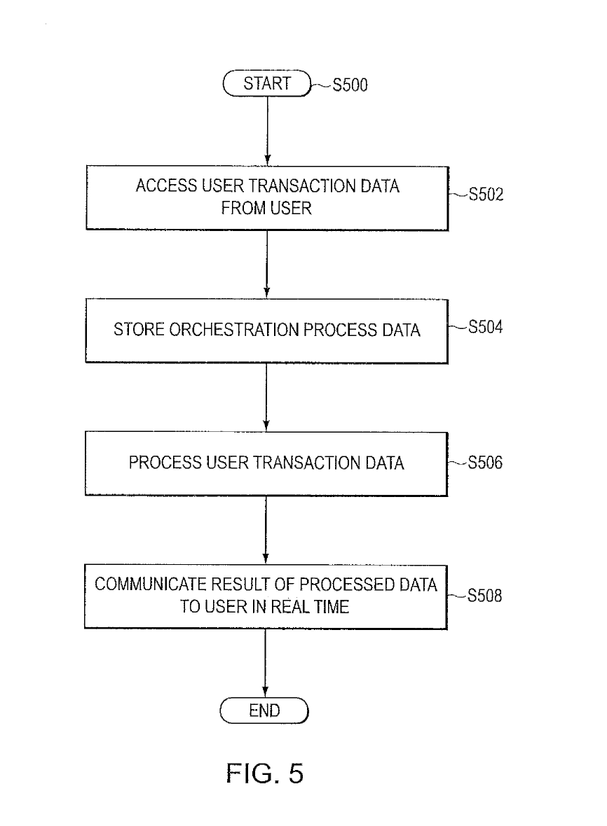

FIG. 5 is a flow diagram illustrating an exemplary method for real-time data processing. The data processing method can be initiated at step S500 by a user initiated action or automatically started without user initiation. In step S502, the user transaction data can be accessed from the user database by a data access unit. The data access unit can be configured to access the data based on the predetermined conditions of the REST API as discussed above. The user can retain full control over the user database. The user database can be located inside the network barrier, or preferably within the network firewall. The user transaction data may contain sensitive user information that may not be stored in the real-time data processing apparatus or in any non-volatile storage medium outside of the full control of the user.

Next, in step S504 orchestration process data can be stored, by a data storage, in the real-time data processing apparatus. The orchestration process data can be related to the user transaction data and can be used to manipulate or process the user transaction data as requested by the user. The orchestration process data can contain less sensitive information than the user transaction data and thus can be stored in the real-time data processing apparatus, outside of the network firewall or outside the full control of the user.

In step S506, the user transaction data can be manipulated or processed, by a transaction processing unit, based on the orchestration process data. The transaction processing unit can process the user transaction data based on the predetermined conditions of the REST API and exemplary commands as discussed above. The processed user transaction data is not stored in the real-time data processing apparatus. Rather, in step S508 the processed user transaction data can be communicated in real-time, by a transaction data communication unit, to the user within the network firewall. The processed user transaction data can be communicated in the predetermined manner set forth by the communicator such as the REST API, Java servlet or JSON as discussed above. Thus, no database storage of the processed user transaction can take place outside the network firewall.

The embodiments of the real-time data processing system as set forth above are intended to be illustrative and not limiting. Various changes may be made without departing from the spirit and scope of the invention.

What is claimed is:

1. A real-time data processing apparatus that is connected to a user over a network, the real-time data processing apparatus comprising:
a data access unit that accesses user transaction data from the user;
a data storage that stores orchestration process data that includes information relating to a processing of the user transaction data;
a transaction processing unit that: i) accesses the user transaction data from the data access unit, ii) accesses the orchestration process data from the data storage, and iii) processes the user transaction data using the orchestration process data; and
a transaction data communication unit that communicates a result of the processed user transaction data in real-time to the user, wherein the real-time data processing apparatus does not store the accessed user transaction data in a non-volatile storage medium.

2. The real-time data processing apparatus according to claim 1, wherein
the user transaction data includes a transaction request and user information relating to the transaction request, and
the user information includes confidential user data.

3. The real-time data processing apparatus according to claim 2, wherein the user transaction data corresponds to a workflow transaction.

4. The real-time data processing apparatus according to claim 1, wherein the data storage stores user authentication data to authenticate the user prior to the processing of the user transaction data.

5. The real-time data processing apparatus according to claim 1, wherein the orchestration process data includes at least one of definitions and rules for performing workflow processes.

6. The real-time data processing apparatus according to claim 1, wherein the data access unit automatically accesses the user transaction data without a user-initiated action.

7. The real-time data processing apparatus according to claim 2, further comprising a user interface that receives the transaction request and the user information.

8. The real-time data processing apparatus according to claim 7, wherein the data access unit accesses the user transaction data in response to a user-initiated action on the user interface.

9. The real-time data processing apparatus according to claim 7, wherein the user interface includes a web-based input by which the transaction request and the user information is received.

10. The real-time data processing apparatus according to claim 1, wherein prior to completion of the processing of the user transaction data, the transaction data communication unit communicates a preliminary result of the processed user transaction data to a data layer, the preliminary result of the processed user transaction data being different than the result of the processed user transaction data.

11. The real-time data processing apparatus according to claim 10, wherein the data layer is under full control of the user and accessible by the user.

12. The real-time data processing apparatus according to claim 10, wherein the preliminary result of the processed user transaction data is encrypted data, the encrypted data being located within full control of the user.

13. The real-time data processing apparatus according to claim 10, wherein
the data access unit accesses the preliminary result of the processed user transaction data from the data layer,
the transaction processing unit accesses the preliminary result of the processed user transaction data from the data access unit and performs a final processing of the preliminary result of the processed user transaction data, wherein
the result of the processed user transaction data that is communicated to the user by the transaction data communication unit is a result of the final processing of the preliminary result of the processed user transaction data.

14. The real-time data processing apparatus according to claim 13, wherein the final processing of the preliminary result of the processed user transaction data is initiated by user input that is accessed by the data access unit.

15. The real-time data processing apparatus according to claim 1, wherein
the real-time data processing apparatus is located outside of a network bather, and
the network barrier is a security firewall.

16. The real-time data processing apparatus according to claim 12, wherein unencrypted data including user information is not located outside the full control of the user.

17. The real-time data processing apparatus according to claim 15, wherein the user transaction data being initially located inside the network barrier.

18. The real-time data processing apparatus according to claim 1, wherein the user transaction data being stored under full control of the user.

19. The real-time data processing apparatus according to claim 1, wherein
an entity authorized by the user provides entity data to the real-time data processing apparatus; and
a data communication unit communicates the entity data in real-time to the user, wherein
the real-time data processing apparatus does not store the entity data in a non-volatile storage medium.

20. A method for real-time data processing by a real-time data processing apparatus that is connected to a user over a network, the method comprising:
accessing user transaction data from the user;
storing orchestration process data which includes information relating to a processing of the user transaction data;
accessing the user transaction data and the orchestration process data;
processing the user transaction data using the orchestration process data; and
communicating a result of the processed user transaction data in real-time to the user, wherein the real-time data processing apparatus does not store the accessed user transaction data in a non-volatile storage medium.

21. A computer-readable medium storing orchestration process data that includes information relating to a processing of user transaction data for real-time data processing, which when executed by a processor, causes a computer to function as a real-time data processing apparatus, the real-time data processing apparatus is connected to a user over a network, the computer-readable medium comprising:
a data access unit that accesses user transaction data from the user;
a transaction processing unit that: i) accesses the user transaction data from the data access unit, ii) accesses the orchestration process data from the computer-readable medium, and iii) processes the user transaction data using the orchestration process data; and
a transaction data communication unit that communicates a result of the processed user transaction data in real-time to the user, wherein the computer-readable medium does not store the accessed user transaction data.

22. A data processing system for processing user transaction data to a user in real-time, the data processing system comprising:
a user database that stores user transaction data;
a real-time data processing apparatus comprising:
a data access unit that accesses the user transaction data from the user;
a data storage that stores orchestration process data which includes information relating to a processing of the user transaction data;
a transaction processing unit that: i) accesses the user transaction data from the data access unit, ii) accesses the orchestration process data from the data storage, and iii) processes the user transaction data using the orchestration process data; and
a transaction data communication unit that communicates a result of the processed user transaction data in real-time to the user, wherein the real-time data processing apparatus does not store the accessed user transaction data in a non-volatile storage medium.
